(19) United States
(12) Patent Application Publication
(10) Pub. No.: US 2007/0055979 A1
(43) Pub. Date: Mar. 8, 2007

(54) Method for recording of data stream on multiple recording media

(75) Inventors: Jozef Pieter Van Gassel, Eindhoven (NL); Declan Patrick Kelly, Eindhoven (NL); Bei Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, 5621 BA EINDHOVEN (NL)

(21) Appl. No.: 10/529,683

(22) PCT Filed: Sep. 17, 2003
(86) PCT No.: PCT/IB03/04124

§ 371 Date: Mar. 29, 2005

(30) Foreign Application Priority Data
Oct. 2, 2002 (EP) 02079094.5

(51) Int. Cl. H04N 7/16

(52) U.S. Cl. 725/1

(57) ABSTRACT

The method for recording data comprised in a real time data stream sequentially on multiple recording media reduces the buffer required to temporarily store data from the data stream by starting the change of recording medium when an interruption in the program to be recorded is detected. At least part of the data during the change of recording medium is of less interest to the user and the loss of this data is thus preferred over the loss of data belonging to the program that is to be recorded. By allowing selective loss of data the buffer size is reduced.

The invention relates to a method for recording data comprised in a real time data stream sequentially on multiple recording media comprising the steps of:

recording a first segment of the data stream on a first recording medium

buffering the data stream in a buffer while replacing the first recording medium

by a second recording medium

recording a second segment of the data stream on the second medium.

The invention further relates to a recorder using such a method.

Presently recorders for recording real time data streams have limited recording capacity. Whenever the recording medium is full the recording medium needs to be changed. The change can be either effected manually by the user or can be effected automatically for instance by using a changer mechanism. This change will always require some time during which recording on the recording medium is not possible.

Consequently during this change the data in the data stream is lost. Losing the data presents a severe disadvantage for the user of the recorder intending to record for instance a long movie. A solution to this problem is the use of a buffer to preserve the data until recording is possible again. The size of the buffer must be large enough to store all the data received by the recorder during the change of the recording medium. Such a buffer has the disadvantage that the price of the recorder is increased.

It is the objective of this invention to reduce the amount of buffer needed and thus reduce the cost of the recorder.

This objective is achieved in that the invention is characterized in that the first recording medium is being replaced by the second recording medium during a period between the first segment and the second segment when the data in the data stream is not intended to be recorded.

When changing the recording medium when the recorder receives data which is not intended to be recorded the buffer can be reduced because there is no need for the recorder to record this data and only a small buffer is needed to record the data during the short time period before a new recording medium becomes available again for recording. This small buffer ensures that if data intended for recording arrives while the change of recording medium is not yet completed, the data will not be lost. Since not all data since the start of the change of recording medium needs to be buffered, the size of the buffer can be reduced. Smaller buffers require less memory and are thus less expensive.

An embodiment of the method is characterized in that that period is comprised in an interruption of a program in the data stream where the program is intended to be recorded.

During an interruption of a program the data in the data stream is not intended to be recorded and consequently it is of no importance to buffer this data. The size of the buffer can therefore be reduced compared to the situation where the data in the interruption of the program also needs to be buffered and recorded.

A further embodiment of the method is characterized in that the period is comprised in an advertisement.

Advertisements are not part of the program intended to be recorded and when a change of recording medium is effected during an advertisement the size of the buffer can be reduced compared to the situation where the data of the advertisement also needs to be buffered and recorded

A further embodiment of the method is characterized in that the period is comprised in a scene change.

During programs there are often scene changes. Since there is no relevant data in the scene change the change of recording medium can be effected during a scene change and the size of the buffer can be reduced compared to the situation where the data of the scene change also needs to be buffered and recorded

A further embodiment of the method is characterized in that the program is a sports program.

Sports programs are often interrupted for several reasons. This allows the change of the recording medium during this interruption because the loss of data during an interruption is less annoying to the viewer than loss of data during the sports game. Many sports programs comprise interruptions to the actual game. These interruptions may be integral part of the game such as the pause between two sessions or unscheduled but in either case the actual game itself has stopped at such a moment.

A further embodiment of the method is characterized in that the interruption is due to an injury.

An injury of a participant of the sparts game is an unscheduled pause in a sports game and can thus be used to change the recording medium.

A further embodiment of the method is characterized in that the interruption is due to a time out. A time out is of less importance to a sports game than the actual game itself. During the time-out a loss of data is less annoying compared to data loss during the sports game. A smaller buffer can therefore be used.

A further embodiment of the method is characterized in that the period is comprised in a list of credits. Often the list of credits is of less importance to the user and it is less annoying if a part of the credits is missing, compared to when part of a movie is missing. It is there fore advantageous to change the recording medium during the credits because a loss of data can be tolerated, resulting in a smaller buffer compared to the situation when no data loss is tolerated.

A further embodiment of the method is characterized in that the period is comprised in a section of the data stream where the data in the data stream has a low bit rate.

When selecting a section of the data stream where the bit rate of the data stream is low, the size of the buffer can be reduced while still recording the entire data stream without loss of data. At a lower bit rate less buffer is used for recording a section of a given duration compared to a section of equal duration but with a higher bit rate.

A further embodiment of the method is characterized in that the program is a music program and that the period is a period between a first song and a second song.

Music programs are particularly suited for applying the method according to the invention since music often comprises pauses. A pause can almost always be found just before the start of a song as well as immediately after a song. Using a smaller buffer the method can still start the recording while the change of recording medium has not yet been completed

A further embodiment of the method is characterized in that the interruption is determined from an electronic program guide.

Electronic program guides indicate when a program starts, when it ends and when interruptions are scheduled. An example is a long movie which is divided in two sections by a news cast. Changing the recording medium during the news cast is of no consequence since the news cast was not intended to be recorded anyway.

Most interruptions listed in an electronic program guide will be longer than the time needed to replace the recording medium, in which case a buffer is not needed.

A further embodiment of the method is characterized in that a start of the interruption is determined from an information block transmitted together with the program.

The content provider can include an indication in the data stream that an interruption is starting. This can be implemented in the same way as currently the German VPS system indicates the start and end of a program to start and stop the recording by a VCR. Alternatively this information that an interruption is starting can be transmitted to the recorder via teletext. Both systems allow the quasi real time transfer of this information, allowing sufficiently exact control of the start of the change of the recording medium.

In this way the recorder does not need to determine the content of the picture or audio of the data stream but can use existing hardware in the recorder to determine the opportune moment for effecting the change of recording medium.

A further embodiment relates to a recorder for recording a program in a data stream using more than one recording medium using one of the methods as claimed in claims 1 to 10.

The invention will now be described based on figures.

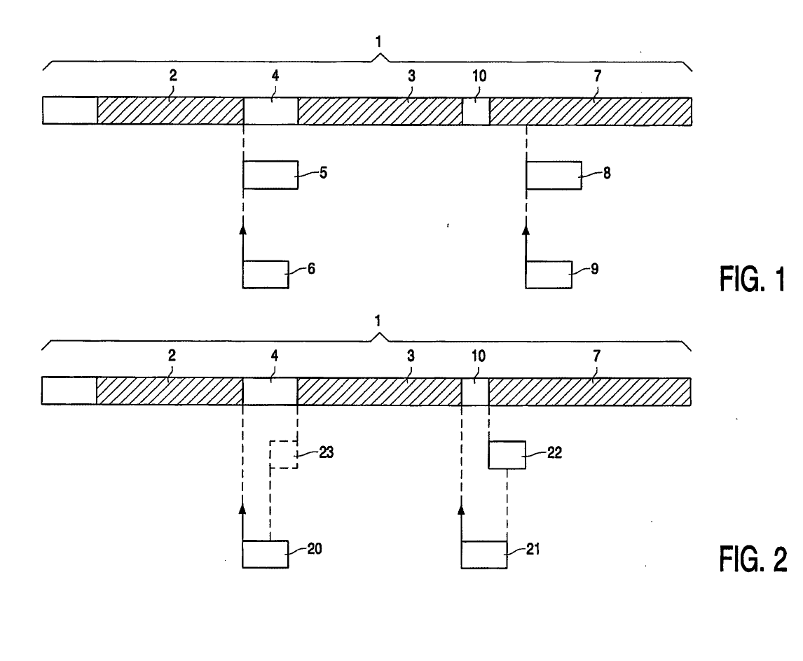

FIG. 1 shows a data stream comprising a program that is intended to be recorded and the instances of change of recording medium and the required buffering.

FIG. 2 shows a data stream comprising a program that is intended to be recorded when the instances of changing the recording medium coincide with an interruption of the program and the effect on the required buffering.

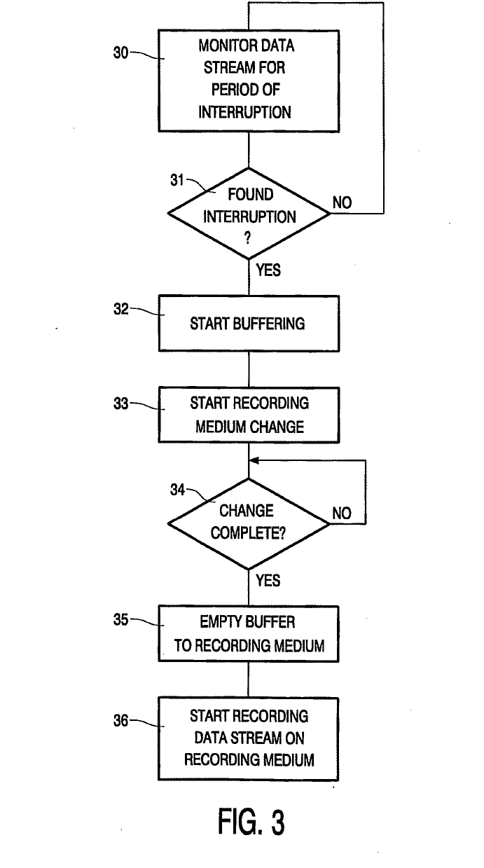

FIG. 3 shows a flow chart implementing the method according to the invention

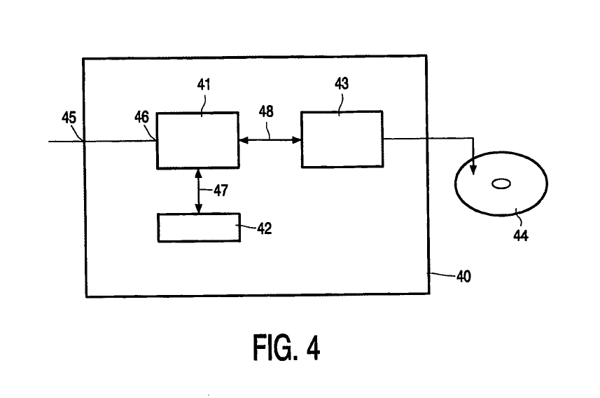

FIG. 4 shows a recorder for implementing the method according to the invention.

FIG. 1 shows a data stream comprising a program that is intended to be recorded and the instances of change of recording medium and the required buffering.

FIG. 1 shows a situation where the change of recording medium 9 is not aligned with an interruption 10 of the program but is in the middle of the third program section 7. In this situation there is no relationship between the program content and the change of the recording medium 9 because the change of recording medium 9 is based purely on the recording medium being full and a new recording medium being needed. In order not to lose data of the third program section 7 buffering 8 is needed.

In contrast to this the method of the present invention does not change the recording medium when the recording medium is full, but depending on the content of the program intended to be recorded. This can result in a change of recording medium when the recording medium is not completely full.

This is also illustrated in FIG. 1.

The data stream 1 comprises a program intended to be recorded which comprises of three program sections 2, 3, 7 separated by two periods 4, 10 which form interruptions to the program and effectively divide the program into the three program sections 2, 3, 7. When the program is too large too fit on a single recording medium and is to be recorded without losing data of the program sections 2, 3, 7, the recording medium must be changed somewhere between the start of the first program section 2 and the last program section 7. The first change 6 starts coinciding with the start of the interruption and, in this example, takes less time than the duration of the interruption 4, thus ending before the start of the second program section 3. Even if no buffering would be used the first program section 2 and the second program section 3 would still be recorded without loss of data. Thus if the change of recording medium is properly aligned with a program interruption the objective of the invention is achieved.

When some of the data in the first interruption 4 is to be recorded, buffering 5 is needed that buffers the data until the new recording medium is available for recording.

It is to be noted that the size of the buffer must in that case be sufficient to not only buffer some of the data of the interruption 4, but must also be large enough to buffer the first part of the second section because when the new recording medium is available for recording it will take some time to transfer the data in the buffer to the recording medium before the data of the first part of the second program section 3 can be recorded.

FIG. 2 shows a data stream 1 comprising a program that is intended to be recorded when the instances 20, 21 of changing the recording medium coincide with an interruption 4, 10 of the program and the effect on the required buffering.

In FIG. 2 the data stream 1, like in FIG. 1, comprises a program intended to be recorded which comprises three program sections 2, 3, 7 seperated by two periods 4, 10 which form interruptions to the program and effectively divide the program into the three program sections 2, 3, 7.

A reduction in buffer size can be achieved in the following manner.

When the change of recording medium 21 is aligned with the end of the program section 2, i.e. the start of an interruption 4, and the duration of the change of recording medium 20 is less than the duration of the interruption 4 no buffer is needed at all because the recording starts again on the new recording medium before the start of the next program section 3, thus achieving the objective of the invention.

When the change of recording medium 21 is aligned with the start of the interruption 10 but is of a longer duration than the interruption 10 a buffer is needed to buffer the data of the program section 7 following the interruption 10 until the recording medium is ready to accept the data of the program section 7. Since the buffer doesn't need to be large enough to buffer the entire interruption 10 it's size can be reduced, thus achieving the objective of the invention.

It should be noted that the detection of the interruption of the program can be implemented in many different ways. Processing the data of the program, i.e. audio or video, to find scene changes, titles at the beginning or the end of a program, advertisements, silence between pieces of music, i.e. between songs, absence of movement and many other indications for the detection of interruption 4, 10 or sections which are of less interest to the user have been contemplated in the prior art for instance for removing advertisements from a recording and can be equally successfully employed for determining the optimum time according to this invention to change the recording medium. Further possibilities include the transmission of a signal by the content provider of the program intended for recording that an interruption starts, in a similar fashion as in the VPS system where the start of a program is indicated and used by the recorder to start the recording of the program exactly on time even if the start of the program is delayed.

A further option is to use information obtained from an electronic program guide to determine interruptions to the program and schedule the change of recording medium accordingly.

The buffer can be a circulating buffer where only the most recent information is preserved i.e. where the older data is overwritten by the latest data. That way the size of the buffer is used optimally since the full buffer size is available at the start of the program section because the data already present in the buffer from before the start of the program section 3, 7 can be retrieved and recorded on the recording medium. The buffer area is after retrieval of the data available again for buffering new data. This means that some data from the interruption can be recorded while the full buffer can still be used for storing the data in the first part of the program section.

FIG. 3 shows a flow chart implementing the method according to the invention

To detect an interruption the first step 30 of the method comprises the monitoring of the data in the data stream for particular types of interruptions. In the second step 31 a decision is taken whether a suitable interruption is found. If a suitable interruption is not found the method returns to the first step 30 to continue monitoring the data in the data stream. If a suitable interruption is found the method proceeds to the third step 32 where the change of the recording medium is started. After this the method proceeds to the fourth step 33 where the buffering is started. Depending on the size of the buffer and the objective of buffering i.e. preventing any loss of data or tolerating loss of data of the interruption, the comprises the third step 32 and the fourth step 33 can be interchanged. After the fourth step 33 the method proceeds to the fifth step 34 where the completion of the change of recording medium is determined. If the change of recording medium is not yet completed the method will return to the fifth step 34 until the completion is detected. When the completion of the change of recording medium is detected the method proceeds to the sixth step 35 where the content of the buffer is being transferred to the new recording medium now available after the recording medium change. While the buffer is being transferred to the new recording medium the current data from the data stream must still be stored in the buffer since the recording medium is not yet available for recording the current data.

Once the buffered data is stored on the recording medium the method proceeds to the seventh step where the current data stream can be recorded on the recording medium directly without needing to use the buffer in order to prevent data loss.

A buffer is often already present in a recorder for other purposes than buffering during a change of the recording medium but such a buffer can be substantially smaller since the amounts of data that need to be buffered in regular operation are substantially smaller than the amount of data arriving during the change of a recording medium which lasts several seconds.

FIG. 4 shows a recorder for implementing the method according to the invention.

The recorder 40 comprises a data processing unit 41, a memory 42 and a basic engine 43. The recorder further comprises a recorder input 45 where the data stream is received from an external source. The recorder input is connected to the input 46 of the data processing unit 41. The data processing unit 41 performs multiple functions such as formatting the data stream for recording and determining the recording strategy, and also performs the method as outlined in the description of FIG. 3. To be able to perform the method the data processing unit 41 performs the detection of an interruption, issues the command to the basic engine 43 to start a change of recording medium 44, directs data to the buffer 42 over the bidirectional bus 47, retrieves the buffered data from the buffer 42 or passes on the data directly to the basic engine when no buffering is needed. To communicate with the basic engine a bidirectional data bus is provided between the basic engine 43 and the data processing unit 41. Both data and commands can be sent over such a bus.

The replacement of the recording medium can be effected in different ways.

A disc changer, integrated into the recorder 40 can be used, for example a so called carousel loader which is well known from CD players where multiple CDs can be inserted in a carousel and the carousel is rotated to bring the correct CD to the reading position. In a recorder the recording medium can be brought to the recording position by the same carousel mechanism.

Alternatively the recorder can be equiped with a single loading tray and the loading tray can be automatically opened when it is decided according to the method of the invention to change the recording medium. The user is alerted by opening the loading, possibly supported by audio/visual alarms, and invited to insert a new recording medium by hand. The alert and invitation can be generated by means included in the recorder such as a buzzer or a light, but can also be generated by the recorder such that the alarm is produced through a television set connected to the recorder 40.

The alarm sound is played through the speakers of a television set and the invitation is displayed by the television set.

The data processing unit can determine the opportune moment to change the recording medium from the video or audio content of the data stream or can simply extract control signals sent by the content provider along with the program in the data stream, for instance in the form of control signals comparable to the VPS system, or by teletext.

1. Method for recording data comprised in a real time data stream sequentially on multiple recording media comprising the steps of:
recording a first segment of the data stream on a first recording medium
buffering the data stream in a buffer while replacing the first recording medium
by a second recording medium
recording a second segment of the data stream on the second medium
characterized in that the first recording medium is being replaced by the second recording medium during a period between the first segment and the second segment when the data in the data stream is not intended to be recorded.

2. Method for recording data comprised in a real time data stream as claimed in claim 1,
characterized in that the period is comprised in an interruption of a program in the data stream where the program is intended to be recorded.

3. Method for recording data comprised in a real time data stream as claimed in claim 1,
characterized in that the period is comprised in an advertisement.

4. Method for recording data comprised in a real time data stream as claimed in claim 1,
characterized in that the period is comprised in a scene change.

5. Method for recording data comprised in a real time data stream as claimed in claim 2,
characterized in that the program is a sports program.

6. Method for recording data comprised in a real time data stream as claimed in claim 5,
characterized the interruption is due to an injury

7. Method for recording data comprised in a real time data stream as claimed in claim 5,
characterized in that the interruption is due to a time out.

8. Method for recording data comprised in a real time data stream as claimed in claim 1,
characterized in that the period is comprised in a list of credits.

9. Method for recording data comprised in a real time data stream as claimed in claim 1,
characterized in that the period is comprised in a section of the data stream where the data in the data stream has a low bit rate.

10. Method for recording data comprised in a real time data stream as claimed in claim 2,
characterized in that the program is a music program and that the period is a period between a first song and a second song.

11. Method for recording data comprised in a real time data stream as claimed in claim 2,
characterized in that the interruption is determined from an electronic program guide.

12. Method for recording data comprised in a real time data stream as claimed in claim 2,
characterized in that the start of the interruption is determined from an information block transmitted together with the program.

13. Recorder for recording a program in a data stream using more than one recording medium using one of the method as claimed in claim 1.
